(19) United States
(12) Patent Application Publication
(10) Pub. No.: US 2026/0267209 A1
(43) Pub. Date: Sep. 10, 2026

(54) LIGHTING APPARATUS

(71) Applicant: SONY GROUP CORPORATION, Tokyo (JP)

(72) Inventor: Shingo OHKAWA, Kanagawa (JP)

(73) Assignee: SONY GROUP CORPORATION, Tokyo (JP)

(21) Appl. No.: 19/162,666

(22) PCT Filed: Feb. 15, 2024
(86) PCT No.: PCT/JP2024/005187

§ 371 Date: Sep. 5, 2025

(30) Foreign Application Priority Data
Mar. 20, 2023 (JP) 2023-043779

(51) Int. Cl. G03B 21/20; G02F 1/01

(52) U.S. Cl. CPC G03B 21/204; G02F 1/0121; G03B 21/2066; G03B 21/208; G02F 2203/50

(57) ABSTRACT

A lighting apparatus includes a light-emitting unit that emits light in a first wavelength band; a phase modulation unit that performs spatial light phase modulation on incident light from the light-emitting unit; a wavelength conversion unit that wavelength-converts incident light from the phase modulation unit, thereby emitting light in a second wavelength band different from the first wavelength band; and a lens optical system that guides emitted light from the wavelength conversion unit to a projection lens, in which the phase modulation unit generates a reproduction image that is formed in the wavelength conversion unit as a reproduction image of the first wavelength band, and the lens optical system forms a reproduction image of the second wavelength band in an optical path between the projection lens and the lens optical system on the basis of the emitted light from the wavelength conversion unit.

### TECHNICAL FIELD

The present technology relates to a lighting technology in which a wavelength conversion unit wavelength-converts a reproduction image, which is generated by performing spatial light phase modulation on incident light from a light-emitting unit, and a projection lens projects it.

### BACKGROUND ART

A technology of generating an image (reproduction image) with a desired light intensity distribution on a predetermined image plane by spatial light phase modulation is known.

For example, a liquid-crystal panel is used as a phase modulator that performs spatial light phase modulation. When the driving state of a pixel in a phase modulator (e.g., the orientation state of liquid-crystal molecules) is changed, the phase modulation amount (phase delay amount) for incident light at the pixel changes. At this time, if the driving state of the pixel is changed, the diffraction angle of light incident on the pixel changes. Thus, the phase modulator is capable of setting the angle of emission of emitted light, i.e., the amount of bending of light for each pixel by setting the phase modulation amount for each pixel. With such a setting of the amount of bending of light for each pixel, it is possible to make some regions on the image plane dense with light and other regions sparse with light, thereby forming a desired light intensity distribution on the image plane. That is, it is possible to generate a reproduction image with a desired light intensity distribution.

Spatial light intensity modulation is also an example of the spatial light modulation for generating a reproduction image. In the spatial light intensity modulation, a reproduction image with a desired light intensity distribution is generated by using an intensity modulator configured to be capable of changing the transmittance or reflectance of each pixel with respect to incident light.

Unlike the reproduction image generation by such spatial light intensity modulation, the reproduction image generation by spatial light phase modulation as described above does not need to absorb or reflect part of incident light in generating a reproduction image with a desired light intensity distribution. Therefore, there is an advantage that it improves the incident light utilization efficiency.

Here, for a lighting apparatus that projects light subjected to spatial light modulation through a projection lens, it is also conceivable to take a configuration to wavelength-convert the light subjected to the spatial light modulation and project the wavelength-converted light through the projection lens.

For example, Patent Literature 1 below has disclosed a technology in which a spatial light modulator that modulates a phase distribution of laser light is controlled to irradiate a phosphor, and the fluorescent and laser light are mixed together and projected through a projection lens to change the light distribution pattern.

Moreover, Patent Literature 2 below has disclosed a technology for generating an excitation light pattern by a spatial light modulator that functions as a hologram, irradiating a phosphor with it, and projecting the light pattern from the phosphor.

### CITATION LIST

### Patent Literature

Patent Literature 1: WO 2018/179093
Patent Literature 2: Japanese Patent Application Laid-open No. 2021-57147

### DISCLOSURE OF INVENTION

### Technical Problem

Here, fluorescent luminescence is substantially completely diffused. Therefore, if the light utilization efficiency is increased in a lighting apparatus such as that in Patent Literature 1 or 2 above, the numerical aperture (NA) of the projection lens increases and the lighting apparatus increases in size and weight.

Moreover, as the NA of the projection lens increases, aberrations in the projection lens may cause a reduction in resolution of the projected image.

The present technology has been made in the above-mentioned circumstances and it is an objective of the present technology to make it possible to reduce the NA of a projection lens in a lighting apparatus in which a reproduction image generated by performing spatial light phase modulation on incident light from a light-emitting unit is wavelength-converted by a wavelength conversion unit and projected by the projection lens, thereby reducing the size and weight of the lighting apparatus and improving the resolution of the projected image.

### Solution to Problem

A lighting apparatus according to the present technology includes: a light-emitting unit that emits light in a first wavelength band; a phase modulation unit that performs spatial light phase modulation on incident light from the light-emitting unit; a wavelength conversion unit that wavelength-converts incident light from the phase modulation unit, thereby emitting light in a second wavelength band different from the first wavelength band; and a lens optical system that guides emitted light from the wavelength conversion unit to a projection lens, in which the phase modulation unit generates a reproduction image that is formed in the wavelength conversion unit as a reproduction image of the first wavelength band, and the lens optical system forms a reproduction image of the second wavelength band in an optical path between the projection lens and the lens optical system on the basis of the emitted light from the wavelength conversion unit.

That is, the reproduction image of the second wavelength band obtained by the wavelength conversion of the wavelength conversion unit is not directly magnified and projected by the projection lens, but the reproduction image of the second wavelength band is formed once in front of the projection lens, and then the reproduction image of the second wavelength band is magnified and projected by the projection lens. Accordingly, the numerical aperture (NA) of the projection lens can be reduced as compared to a case where the reproduction image of the second wavelength band obtained by the wavelength conversion of the wavelength conversion unit is directly magnified and projected by the projection lens.

### BRIEF DESCRIPTION OF DRAWINGS

FIG. 1 A diagram showing a configuration example of a lighting apparatus as a first embodiment.

FIG. 2 A diagram showing an optical path of a reproduction image center in the lighting apparatus as the first embodiment.

FIG. 3 A diagram showing a configuration of a lens optical system as a comparative example.

FIG. 4 A diagram showing a configuration example of a lighting apparatus as a modified example of the first embodiment.

FIG. 5 A diagram showing a configuration example of a lighting apparatus as a second embodiment.

FIG. 6 A front view of a wavelength conversion element of the lighting apparatus of the second embodiment.

FIG. 7 A timing chart showing respective operations of a wavelength conversion unit, a phase modulator, and a light-emitting unit in the second embodiment.

FIG. 8 A diagram showing a configuration example of a lighting apparatus as a third embodiment.

FIG. 9 A front view of a wavelength conversion element of the lighting apparatus of the third embodiment.

FIG. 10 A timing chart showing respective operations of a wavelength conversion unit, a phase modulator, and a light-emitting unit in the third embodiment.

FIG. 11 A diagram showing a configuration example of a lighting apparatus as a fourth embodiment.

FIG. 12 A diagram showing an example of dividing a phase modulation unit into regions in the fourth embodiment.

FIG. 13 A timing chart diagram showing operations of a phase modulator and a light-emitting unit in the fourth embodiment.

FIG. 14 A view showing a structure example of a red laser.

FIG. 15 A diagram showing a configuration example of a lighting apparatus as a fifth embodiment.

FIG. 16 An explanatory view of a wavelength conversion unit as a modified example.

FIG. 17 A diagram showing a configuration example of a lighting apparatus as a modified example.

### MODE(S) FOR CARRYING OUT THE INVENTION

Hereinafter, embodiments according to the present technology will be described in the following order with reference to the accompanying drawings.
<1. First Embodiment>
<2. Second Embodiment>
<3. Third Embodiment>
<4. Fourth Embodiment>
<5. Fifth Embodiment>
<6. Modified Examples>
<7. Summary of Embodiments>
<8. Present Technology>

### 1. First Embodiment

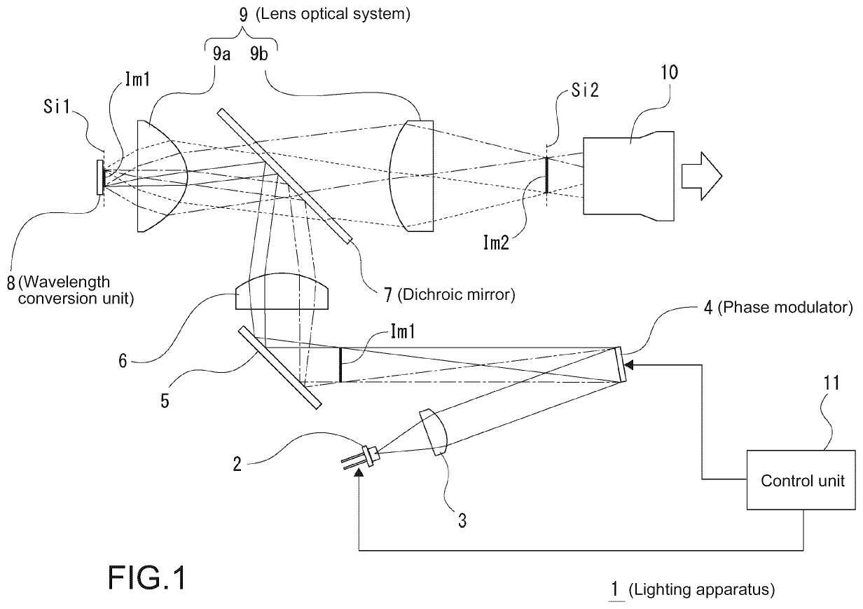

FIG. 1 is a diagram showing a configuration example of a lighting apparatus 1 as a first embodiment according to the present technology.

As shown in the figure, the lighting apparatus 1 includes a light-emitting unit 2, a collimating lens 3, a phase modulator 4, a mirror 5, a collimating lens 6, a dichroic mirror 7, a wavelength conversion unit 8, a lens optical system 9, a projection lens 10, and a control unit 11.

The light-emitting unit 2 emits light in a first wavelength band. The light-emitting unit 2 includes one or more light-emitting elements. For example, a semiconductor laser or a light emitting diode (LED) may be used as the light-emitting element.

In this example, it is assumed that the light in the first wavelength band emitted by the light-emitting unit 2 is, for example, blue (B) light.

The collimating lens 3 focuses the light emitted by the light-emitting unit 2 and emits parallel light.

The phase modulator 4 performs spatial light phase modulation on incident light from the collimating lens 3, in other words, incident light from the light-emitting unit 2 through the collimating lens 3.

In this example, a reflective liquid-crystal panel is used as the phase modulator 4.

As is well known, the emission direction of incident light can be changed to a desired direction on a pixel-by-pixel basis depending on spatial light phase modulation. This action makes it possible to focus incident light to a desired position, i.e., form an image at the desired position. Moreover, as described above, setting the amount of bending of light for each pixel can make some regions on the image plane dense with light and other regions sparse with light, thereby forming a desired light intensity distribution on the image plane. That is, it is possible to generate a reproduction image with a desired light intensity distribution.

It should be noted that as described above, the amount of bending of light for each pixel can be adjusted by changing the phase modulation amount for each pixel, specifically, the driving state of the pixel (or the orientation state of liquid-crystal molecules in a case of a liquid-crystal panel).

In this example, the spatial light phase modulation by the phase modulator 4 is provided with an action of focusing the incident light, so that incident light from the light-emitting unit 2 is focused once in the optical path between the mirror 5 and the phase modulator 4. That is, in this example, a reproduction image of the first wavelength band is once formed in the optical path between the mirror 5 and the phase modulator 4.

It should be noted that in this manner, the reproduction image of the first wavelength band is formed once in order to improve the ease of layout of optical components.

Here, FIG. 1 shows light paths at upper and lower ends of the reproduction image of the first wavelength band separately for the emitted light from the phase modulator 4. Specifically, the optical path at the upper end is shown by the solid lines and the optical path at the lower end is shown by the long dashed short dashed lines.

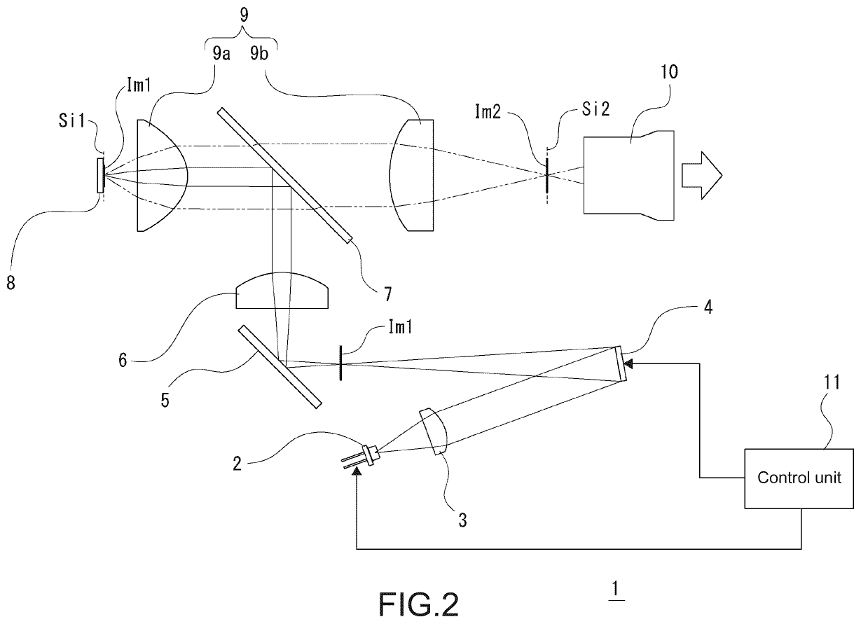

For the emitted light from the phase modulator 4, the optical path in the center of the reproduction image of the first wavelength band is shown by the solid lines in FIG. 2.

The emitted light from the phase modulator 4 is made incident on the mirror 5 as divergent light, and the collimating lens 6 converts the divergent light to parallel light and emits it to the dichroic mirror 7.

The dichroic mirror 7 is configured to reflect light in the first wavelength band and transmit light in the other wavelength band. The emitted light from the phase modulator 4, which is reflected by the mirror 5 and enters through the collimating lens 6 as described above, is reflected by the dichroic mirror 7.

The emitted light from the phase modulator 4 reflected by the dichroic mirror 7 enters a relay lens 9a in a lens optical system 9, is converted to converged light in the relay lens 9a, and enters the wavelength conversion unit 8.

The wavelength conversion unit 8 wavelength-converts the emitted light from the phase modulator 4 that enters through the relay lens 9a as described above, thereby emitting light in a second wavelength band different from the first wavelength band.

Specifically, in this example, it is assumed that the light in the second wavelength band is, for example, R (red) light.

In this example, a reflective phosphor is used in the wavelength conversion unit 8. In this case, the wavelength-converted light, i.e., the light in the second wavelength band, is emitted as reflected light from the wavelength conversion unit 8. Moreover, the reflected light is emitted as divergent light.

Here, the lighting apparatus 1 is designed so that light in the first wavelength band entering the wavelength conversion unit 8 through the relay lens 9a is focused at the wavelength conversion unit 8. That is, in the lighting apparatus 1, the reproduction image of the first wavelength band is formed again in the wavelength conversion unit 8.

Hereinafter, the image plane of the reproduction image of the first wavelength band in the wavelength conversion unit 8 will be referred to as a “first image plane Si1.” In the figure, the reproduction image of the first wavelength band formed at the first image plane Si1 will be referred to as a “first reproduction image Im1.”

FIG. 1 shows the light paths at the position corresponding to the upper end and the position corresponding to the lower end of the reproduction image of the first wavelength band separately for the light in the second wavelength band emitted from the wavelength conversion unit 8. Specifically, the optical path at the position corresponding to the upper end is shown by the long dashed double-short dashed lines and the optical path at the position corresponding to the lower end is shown by the dashed lines.

For the light in the second wavelength band emitted from the wavelength conversion unit 8, the optical path at the position corresponding to the center in the reproduction image of the first wavelength band is shown by the long dashed double-short dashed lines in FIG. 2.

The emitted light from the wavelength conversion unit 8 is guided to the projection lens 10 by the lens optical system 9 including the relay lens 9a.

In this example, the lens optical system 9 is configured as a relay lens optical system including the relay lens 9a and a relay lens 9b.

In the lens optical system 9 of this example, the relay lens 9b is arranged at a position closer to the projection lens 10 than the dichroic mirror 7 in the optical path from the wavelength conversion unit 8 to the projection lens 10, and the emitted light from the wavelength conversion unit 8 is guided through the relay lens 9a, the dichroic mirror 7, and the relay lens 9b to the projection lens 10.

Specifically, the light in the second wavelength band as the divergent light emitted from the wavelength conversion unit 8 is collimated by re-entering the relay lens 9a, passes through the dichroic mirror 7 as parallel light, and enters the relay lens 9b. Then, the light in the second wavelength band is converted to converged light by the relay lens 9b and focused at a position in front of the projection lens 10. That is, the reproduction image of the second wavelength band is formed at a position in front of the projection lens 10.

In this manner, the lens optical system 9 forms the reproduction image of the second wavelength band in the optical path between the projection lens 10 and the lens optical system 9 on the basis of the emitted light from the wavelength conversion unit 8.

Hereinafter, the image plane of the reproduction image of the second wavelength band will be referred to as a “second image plane Si2.” In the figure, the reproduction image of the second wavelength band formed on the second image plane Si2 will be referred to as a “second reproduction image Im2.”

The light in the second wavelength band focused on the second image plane Si2 enters the projection lens 10 and is emitted from the projection lens 10 as divergent light. Accordingly, the reproduction image of the second wavelength band obtained on the second image plane Si2 is magnified and projected by the projection lens 10.

The control unit 11 controls the light-emitting unit 2 and the phase modulator 4.

Specifically, the control unit 11 includes, for example, electronic circuits such as a central processing unit (CPU) and a digital signal processor (DSP), and, for example, controls the start/stop of the light emission operation by the light-emitting unit 2 and controls the amount of emitted light. Moreover, the control unit 11 controls the spatial light phase modulation of the phase modulator 4, specifically, controls the phase modulation amount for each pixel (pixel driving state).

In the lighting apparatus 1 according to the present embodiment described above, the lens optical system 9 forms the reproduction image of the second wavelength band in the optical path between the projection lens 10 and the lens optical system 9 on the basis of the emitted light from the wavelength conversion unit 8.

That is, the reproduction image of the second wavelength band obtained by wavelength conversion in the wavelength conversion unit 8 is not directly magnified and projected by the projection lens 10, but the reproduction image of the second wavelength band is formed once in front of the projection lens 10 and then the reproduction image of the second wavelength band is magnified and projected by the projection lens 10.

By employing such a configuration, the numerical aperture (NA) of the projection lens 10 can be reduced as compared to a case where the reproduction image of the second wavelength band obtained by wavelength conversion in the wavelength conversion unit 8 is directly magnified and projected by the projection lens 10.

The capability of reducing the NA of the projection lens can reduce the size and weight of the lighting apparatus 1. Moreover, the ability to reduce the NA of the projection lens makes it possible to aberrations of the projection lens 10. Thus, it is possible to improve the resolution of the projected image.

Moreover, in the present embodiment of the lighting apparatus 1, the area of the reproduction image of the second wavelength band (second reproduction image Im2) is made larger than the area of the reproduction image of the first wavelength band (first reproduction image Im1) formed in the wavelength conversion unit 8 by setting the focal length of the lens optical system 9. Specifically, the area of the second reproduction image Im2 is made larger than that of the first reproduction image Im1 by setting the focal lengths of the relay lenses 9a and 9b.

Accordingly, it is possible to reduce the amount of blur caused by image surface distortion for the reproduction image of the second wavelength band, and it is possible to suppress the reduction in resolution of the projected image, which is caused by the image surface distortion of the reproduction image of the second wavelength band.

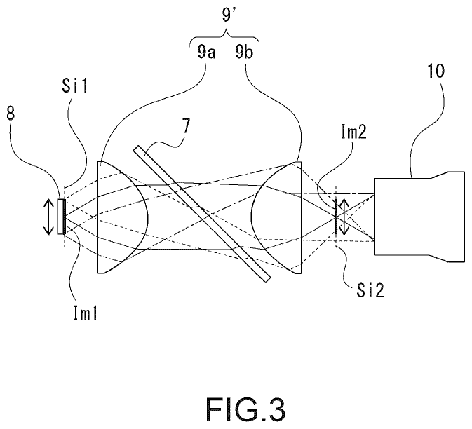

FIG. 3 shows a configuration of a lens optical system 9′ as a comparative example.

This comparative example shows an example in which the area of the first reproduction image Im1 and the area of the second reproduction image Im2 are the same.

In this manner, when the area of the first reproduction image Im1 and the area of the second reproduction image Im2 are set to be the same, the image surface distortion of the second image plane Si2 increases due to the focal length of the lens optical system 9′, which results in reduction in resolution of the second reproduction image Im2.

In contrast, when the area of the second reproduction image Im2 is set to be larger than the area of the first reproduction image Im1 as in the lighting apparatus 1, the image surface distortion of the second image plane Si2 can be reduced and reduction in resolution of the second reproduction image Im2 can be suppressed. Thus, it is possible to improve the resolution of the projected image.

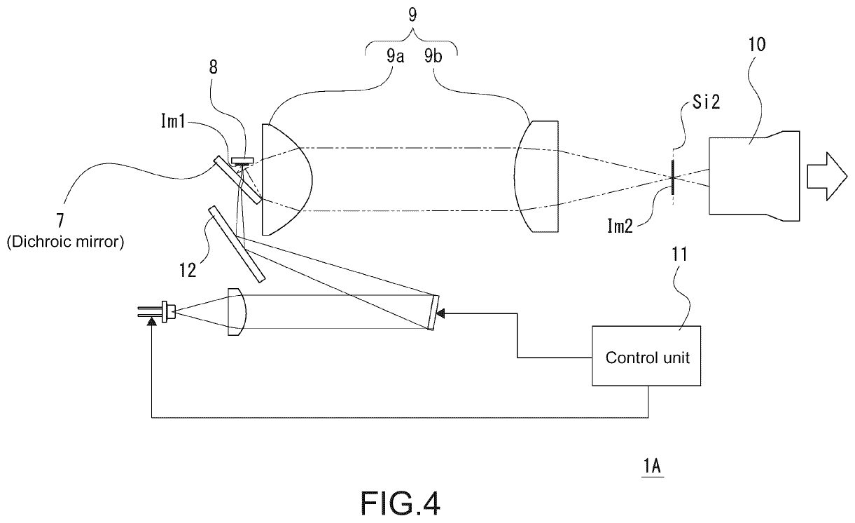

It should be noted that the configuration in which the reproduction image of the first wavelength band is formed once in front of the wavelength conversion unit 8 and then formed again in the wavelength conversion unit 8 has been described above as an example. However, as in a lighting apparatus 1A shown in FIG. 4, a configuration in which the reproduction image of the first wavelength band is not formed once in front of the wavelength conversion unit 8, but is formed directly in the wavelength conversion unit 8 can also be employed.

Hereinafter, portions similar to the portions already described will be denoted by the same reference signs and descriptions thereof will be omitted.

As shown in the figure, in the lighting apparatus 1A, the light in the first wavelength band subjected to the spatial light phase modulation by the phase modulator 4 is reflected by the mirror 12, passes through the dichroic mirror 7, and enters the wavelength conversion unit 8.

In the lighting apparatus 1A, the wavelength-converted light (light in the second wavelength band), which is emitted as reflected light from the wavelength conversion unit 8, is reflected by the dichroic mirror 7 and enters the lens optical system 9.

In this case, the pattern of spatial light phase modulation (driving pattern for each pixel) in the phase modulator 4 is controlled by the control unit 11 so that the light in the first wavelength band emitted from the phase modulator 4 is focused at the wavelength conversion unit 8, i.e., the reproduction image of the first wavelength band is formed in the wavelength conversion unit 8.

In this case, the wavelength-converted light in the second wavelength band is focused by the lens optical system 9 at a position in the optical path between the projection lens 10 and the lens optical system 9. Accordingly, the second reproduction image Im2 is formed on the second image plane Si2.

Hereinafter, the pattern of the spatial light phase modulation in the phase modulator 4 will be referred to as a “phase modulation pattern.”

It should be noted that in the above-mentioned example, the reflective wavelength conversion unit is used as the wavelength conversion unit 8, but a transmissive wavelength conversion unit can also be used.

Moreover, the B light has been described above as an example of the light in the first wavelength band, i.e., excitation light for wavelength conversion unit 8. However, it is also conceivable to use light in the visible light band other than the B light (but not in the second wavelength band) or light in the non-visible light band, such as near ultraviolet light or ultraviolet light, as the excitation light.

Moreover, the configuration in which only the wavelength-converted light in the second wavelength band is projected has been described above as an example. However, it is also conceivable to employ a configuration in which light in the first wavelength band before the wavelength conversion and wavelength-converted light in the second wavelength band are mixed together.

### 2. Second Embodiment

Next, a second embodiment will be described.

The second embodiment relates to time-division switching of wavelengths.

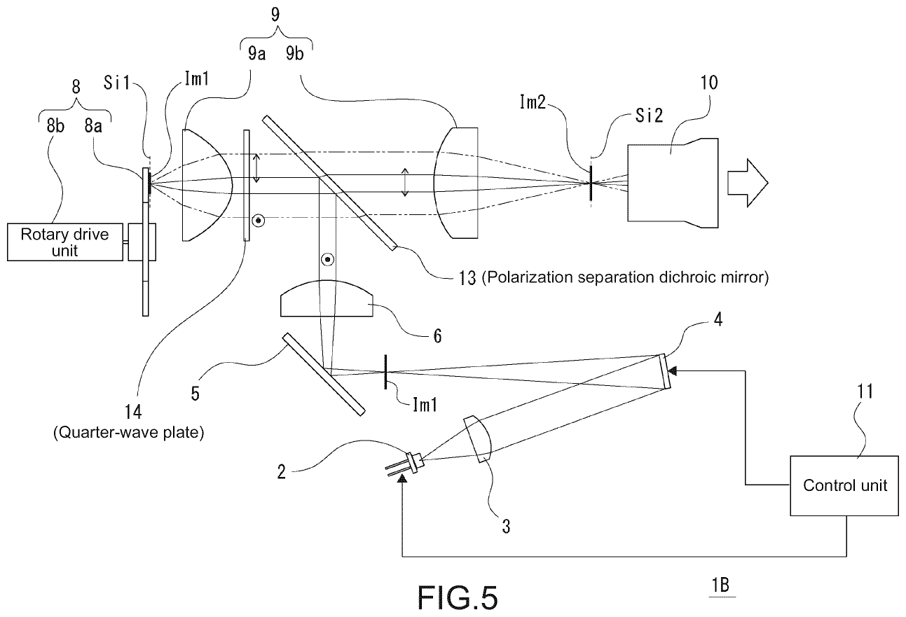

FIG. 5 is a diagram showing a configuration example of a lighting apparatus 1B as the second embodiment.

Differences from the lighting apparatus 1 shown in FIG. 1 are that a wavelength conversion unit 8B replaces the wavelength conversion unit 8, a polarization separation dichroic mirror 13 replaces the dichroic mirror 7, and a quarter-wave plate 14 is provided between the polarization separation dichroic mirror 13 and the relay lens 9a.

The wavelength conversion unit 8B is configured to be capable of time-divisionally switching between a first mode on which incident light in the first wavelength band is wavelength-converted to light in the second wavelength band different from the first wavelength band and a second mode on which the incident light in the first wavelength band is not wavelength-converted.

Specifically, the wavelength conversion unit 8B in this example includes a wavelength conversion element 8a and a rotary drive unit 8b that rotationally drives the wavelength conversion element 8a, as shown in the figure.

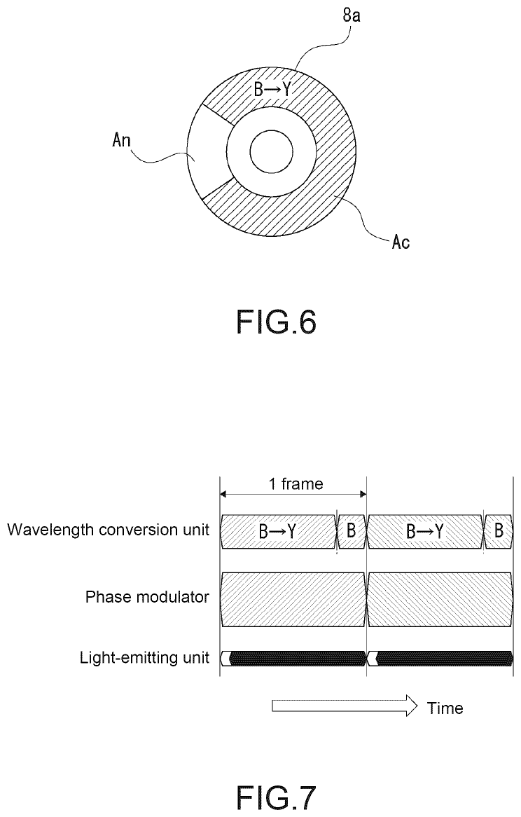

FIG. 6 is a front view of the wavelength conversion element 8a.

As shown in the figure, the wavelength conversion element 8a has a structure in which a conversion region Ac in which the incident light in the first wavelength band is wavelength-converted to the light in the second wavelength band and a non-conversion region An in which the incident light in the first wavelength band is not wavelength-converted are arranged in the circumferential direction. In this example, the conversion region Ac is constituted by a reflective phosphor as in the wavelength conversion unit 8, and the non-conversion region An is configured as a mirror surface.

In the second embodiment, the conversion region Ac performs light-to-yellow (Y) conversion as the wavelength conversion as an example, but the mode of the wavelength conversion is not limited to a particular mode, such as B light-to-R light conversion as in the first embodiment.

When the wavelength conversion element 8a as described above is rotationally driven by the rotary drive unit 8b, wavelength conversion from the first wavelength band to the second wavelength band is performed during the period when the first image plane Si1 overlaps the conversion region Ac, and wavelength conversion from the first wavelength band to the second wavelength band is not performed during the period when the first image plane Si1 overlaps the non-conversion region An. Thus, the above-mentioned time-division switching between the first mode and the second mode is realized.

In FIG. 5, polarized light is used as the light in the first wavelength band in the lighting apparatus 1B, and the light in the first wavelength band reflected by the mirror 5 is linearly polarized in a first direction (e.g., direction perpendicular to the sheet of the figure as shown in the figure) as the polarization direction.

The polarization separation dichroic mirror 13 is configured to reflect linearly polarized light in the first direction as the polarization direction and transmit linearly polarized light in a polarization direction (hereinafter, referred to as “second direction”) orthogonal to the first direction for the light in the first wavelength band. Therefore, the light in the first wavelength band is reflected by the polarization separation dichroic mirror 13 through the mirror 5 and the collimating lens 6 (in the stated order), and enters the wavelength conversion unit 8B through the quarter-wave plate 14 and the relay lens 9a (in the stated order).

Each of the light in the second wavelength band emitted from the wavelength conversion unit 8B on the first mode and the light in the first wavelength band emitted from the wavelength conversion unit 8B on the second mode enters the polarization separation dichroic mirror 13 through the relay lens 9a and the quarter-wave plate 14 (in the stated order).

At this time, each light ray is converted to linearly polarized light having the polarization direction that is the second direction by reciprocating through the quarter-wave plate 14.

The polarization separation dichroic mirror 13 is configured to transmit linearly polarized light in the second direction for the light in the first wavelength band as described above. Therefore, on the second mode, the light in the first wavelength band passes through the polarization separation dichroic mirror 13.

Moreover, the polarization separation dichroic mirror 13 is configured to reflect linearly polarized light in the first direction and transmit linearly polarized light in the second direction for the light in the second wavelength band. Therefore, on the first mode, the light in the second wavelength band passes through the polarization separation dichroic mirror 13.

Accordingly, on the first mode, the light in the second wavelength band obtained by wavelength conversion by the conversion region Ac of the wavelength conversion unit 8B passes through the polarization separation dichroic mirror 13, the second reproduction image Im2 is formed on the second image plane Si2 by the action of the lens optical system 9, and the second reproduction image Im2 is projected through the projection lens 10.

On the other hand, on the second mode, the light in the first wavelength band reflected on the non-conversion region An passes through the polarization separation dichroic mirror 13, the first reproduction image Im1 is formed again on the second image plane Si2 by the action of the lens optical system 9, and the first reproduction image Im1 is projected through the projection lens 10.

FIG. 7 is a timing chart showing respective operations of the wavelength conversion unit 8B, the phase modulator 4, and the light-emitting unit 2 in the lighting apparatus 1B.

In the figure, “I frame” denotes the period during which the reproduction images of the first and second two wavelength bands are projected once each, which in this example corresponds to the rotation period of the wavelength conversion element 8a.

As shown in the figure, in the wavelength conversion unit 8B, the wavelength conversion element 8a is rotationally driven by the rotary drive unit 8b to perform operations of wavelength conversion and wavelength non-conversion (B light output) from the first wavelength band (B light) to the second wavelength band (Y light) for each frame.

Moreover, as for the phase modulator 4, in this case, the light intensity distribution pattern of the reproduction image is the same between the projection period of the reproduction image of the second wavelength band and the projection period of the reproduction image of the first wavelength band as an example, and spatial light phase modulation is performed using the same phase modulation pattern throughout one frame period.

It should be noted that it is also possible to make the light intensity distribution pattern of the reproduction image different between frames.

Moreover, it is also conceivable to make the light intensity distribution pattern of the reproduction image different between the projection period of the reproduction image of the second wavelength band and the projection period of the reproduction image of the first wavelength band.

As for the light-emitting unit 2, it is sufficient that light is emitted on each of the first mode and the second mode of the wavelength conversion unit 8B. Basically, light may be emitted all the time.

Here, in a case where the light intensity distribution pattern of the reproduction image is made different between frames in the phase modulator 4, i.e., in a case where the phase modulator 4 performs spatial light phase modulation using different phase modulation patterns for the frames, a reproduction image with an unintended light intensity distribution may be projected at the switching timing between the frames due to the response time of the liquid crystal if the light-emitting unit 2 is on all the time.

In view of this, it is also conceivable to control the light emission of the light-emitting unit 2 so that a non-light emission period is provided in a head period of the frame to wait for the completion of the response of the liquid crystal as shown in the figure.

It should be noted that as it can be understood from the above description, the control unit 11 is capable of controlling the light emission of the light-emitting unit 2.

By the way, in the second embodiment, the method of rotationally driving the wavelength conversion element 8a as the wavelength conversion unit 8B is employed, and it can suppress the temperature rise of the conversion region Ac because the light irradiation region in the conversion region Ac is dispersed over time. In particular, in a case where a phosphor is used in the conversion region Ac, the light-emitting efficiency of the phosphor tends to decrease as the temperature rises. Therefore, it is possible to improve the light-emitting efficiency in the conversion region Ac because the temperature rise in the conversion region Ac is suppressed as described above.

In the lighting apparatus 1B, the projection switching cycle between the second reproduction image Im2 and the first reproduction image Im1 can be adjusted by the rotation speed of the wavelength conversion element 8a. At this time, it is also possible to make the human perceive the projected image of mixed colors in the first wavelength band and the second wavelength band by the integral effect of the human eye by setting the rotation speed of the wavelength conversion element 8a to be sufficiently high.

It should be noted that the example in which the conversion region Ac in the wavelength conversion element 8a is reflective has been described above, but it can also be transmissive.

Moreover, although the example in which the non-conversion region An is a mirror surface has been described, it may be a diffuse reflection surface. Moreover, in a case where the wavelength conversion unit 8B is transmissive, it may be a diffuse transmission surface.

Moreover, although the example in which the non-conversion region An is provided in the wavelength conversion element 8a for time-divisionally switching and projecting the reproduction images of the different wavelength bands, i.e., the example in which the incident light in the first wavelength band is not wavelength-converted on the second mode has been described above, it is not essential to provide the non-conversion region An.

For example, with a configuration in which a wavelength conversion region in which the light in the first wavelength band is wavelength-converted to the B light (i.e., the light in the first wavelength band is wavelength-converted to light in a particular wavelength band different from the first wavelength band and the second wavelength band) is provided instead of the non-conversion region An as one that emits light in the first wavelength band other than R, G, and B light, such as near-ultraviolet light, from the light-emitting unit 2, it is possible to time-divisionally switch and project reproduction images of two different wavelength bands as in the above-mentioned example.

In view of this point, the second mode of wavelength conversion unit 8B can be defined as a mode on which the incident light in the first wavelength band is not wavelength-converted or the incident light in the first wavelength band is wavelength-converted to the light in the particular wavelength band different from the first wavelength band and the second wavelength band.

Moreover, in the wavelength conversion unit 8B, it is sufficient that the first region (conversion region Ac) in which the incident light in the first wavelength band is wavelength-converted to the light in the second wavelength band and the second region in which the incident light in the first wavelength band is not wavelength-converted or the incident light in the first wavelength band is wavelength-converted to the light in the particular wavelength band are arranged in the circumferential direction as the wavelength conversion element 8a.

### 3. Third Embodiment

In a third embodiment, reproduction images of three wavelength bands are projected by time-division switching.

Here, a case where a full-color image is projected by projecting reproduction images of R, G, and B light as the reproduction images of the three wavelength bands by time-division switching will be taken as an example.

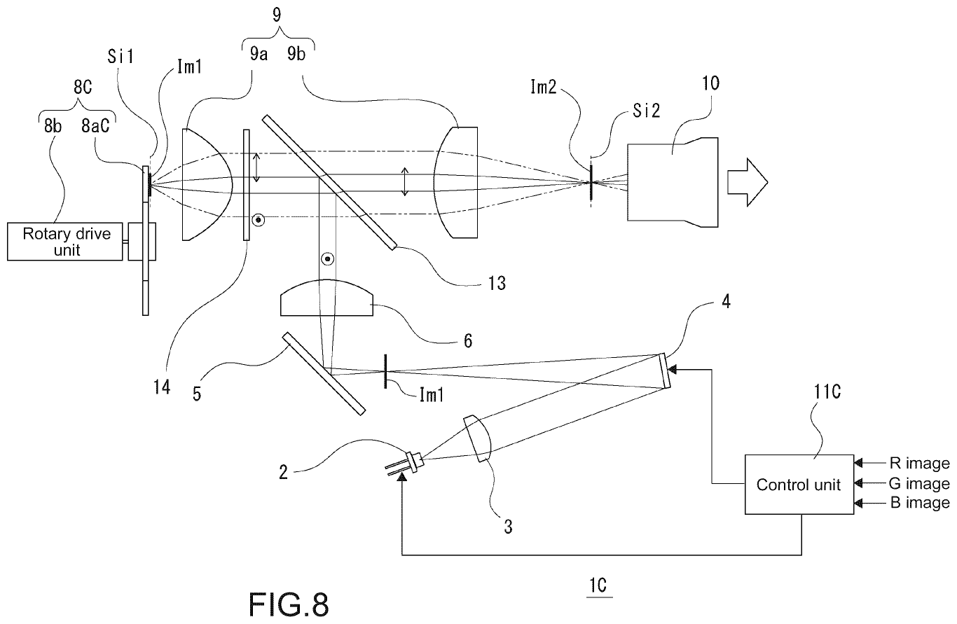

FIG. 8 is a diagram showing a configuration example of a lighting apparatus 1C as the third embodiment.

Differences from the lighting apparatus 1B shown in FIG. 5 above are that a wavelength conversion unit 8C replaces the wavelength conversion unit 8B and a control unit 11C replaces the control unit 11.

The wavelength conversion unit 8C differs from the wavelength conversion unit 8B in that it includes a wavelength conversion element 8aC instead of the wavelength conversion element 8a.

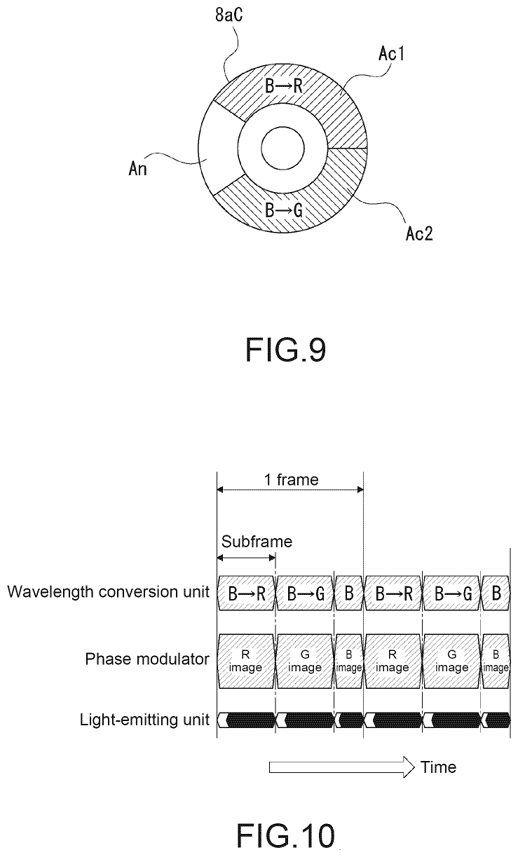

The wavelength conversion element 8aC has a structure in which a first conversion region Ac1, a second conversion region Ac2, and a non-conversion region An are arranged in the circumferential direction in the front view as shown in FIG. 9.

The first conversion region Ac1 converts the incident light in the first wavelength band (B light in this example) to the light in the second wavelength band (R light in this example). Moreover, the second conversion region Ac2 converts the incident light in the first wavelength band to light in the wavelength band different from the first wavelength band and the second wavelength band (G light in this example).

It should be noted that here, the example in which the first conversion region Ac1 and the second conversion region Ac2 are reflective is described, but they can also be transmissive.

In the wavelength conversion unit 8C, when the wavelength conversion element 8aC as described above is rotationally driven by the rotary drive unit 8b, wavelength conversion from the first wavelength band to the second wavelength band (R light in this example) is performed during the period when the first image plane Si1 overlaps the first conversion region Ac1, and wavelength conversion from the first wavelength band to the wavelength band (G light in this example) different from the first wavelength band and the second wavelength band is performed during the period when the first image plane Si1 overlaps the second conversion region Ac2. In addition, during the period when the first image plane Si1 overlaps the non-conversion region An, the wavelength conversion for the light in the first wavelength band is not performed and the light in the first wavelength band is output.

In this manner, the wavelength conversion unit 8C is configured to be capable of time-divisionally switching between the above-mentioned first and second modes and, in addition, a third mode on which the incident light in the first wavelength band is wavelength-converted to light in the wavelength band different from the first wavelength band and the second wavelength band.

In FIG. 8, on the first mode, the light in the second wavelength band obtained by wavelength conversion by the first conversion region Ac1 passes through the polarization separation dichroic mirror 13, the second reproduction image Im2 is formed on the second image plane Si2 by the action of the lens optical system 9, and the second reproduction image Im2 is projected through the projection lens 10.

Moreover, on the third mode, light in the wavelength band different from the first wavelength band and the second wavelength band obtained by the wavelength conversion by the second conversion region Ac2 passes through the polarization separation dichroic mirror 13, and a reproduction image of the particular wavelength band is formed on the second image plane Si2 by the action of the lens optical system 9, and the reproduction image is projected through the projection lens 10.

In addition, on the second mode, the light in the first wavelength band reflected on the non-conversion region An passes through the polarization separation dichroic mirror 13, the first reproduction image Im1 is formed again on the second image plane Si2 by the action of the lens optical system 9, and the first reproduction image Im1 is projected through the projection lens 10.

In this manner, the lighting apparatus 1C is capable of time-divisionally switching and projecting between the reproduction image of the R light (second wavelength band), the reproduction image of the G light (wavelength band different from the first wavelength band and the second wavelength band), and the reproduction image of the B light (first wavelength band).

Here, the lighting apparatus 1C in this example is designed to add a light intensity distribution based on an input image for the reproduction image of each wavelength band. That is, a full-color image is projected by time-divisionally projecting reproduction images that reproduce input images as reproduction images of the respective wavelength bands of R, G, and B.

Specifically, as shown in the figure, the images of the respective wavelength bands of R, G, and B are input to the control unit 11C. The images of the respective wavelength bands are, for example, moving images, and are input sequentially in frame units.

Here, assuming that the wavelength band of emitted light on the second mode of the wavelength conversion unit 8C is a “second-mode wavelength band” and the wavelength band of emitted light on the third mode of the wavelength conversion unit 8C is a “third-mode wavelength band,” the R image, the B image, the G image input to the control unit 11C can be said to be a second-wavelength band image showing a light intensity distribution that should be added to the reproduction image of the second wavelength band, a second-mode wavelength band image showing a light intensity distribution that should be added to a reproduction image of the second-mode wavelength band, and a third-mode wavelength band image showing a light intensity distribution that should be added to a reproduction image of the third-mode wavelength band, respectively.

On the first mode, the control unit 11C controls the phase modulator 4 so that spatial light phase modulation to add the light intensity distribution shown by the second-wavelength band image (R image in this example) to the reproduction image is performed.

Moreover, on the second mode, the control unit 11C controls the phase modulator 4 so that spatial light phase modulation to add the light intensity distribution shown by the second-mode wavelength band image (G image in this example) to the reproduction image is performed.

In addition, on the third mode, the control unit 11C controls the phase modulator 4 so that spatial light phase modulation to add the light intensity distribution shown by the third-mode wavelength band image (B image in this example) to the reproduction image is performed.

Accordingly, for each reproduction image of the R light (second wavelength band), the G light (third-mode wavelength band), and the B light (second-mode wavelength band), it is possible to provide a light intensity distribution depending on the input image of that wavelength band, and a full-color image can be presented by time-divisionally projecting the reproduction images of those wavelength bands.

For confirmation, FIG. 10 shows a timing chart representing the respective operations of the wavelength conversion unit 8C, the phase modulator 4, and the light-emitting unit 2 in the lighting apparatus 1C.

In the figure, “subframe” means an image projection period assigned for each of those wavelength bands (for each of the R light, the G light, and the B light in this example) in order to enable the reproduction image of each wavelength band to be projected in a single frame period. As shown in the figure, the wavelength conversion unit 8C repeats switching between the wavelength conversion mode (first mode) from the B light to the R light, the wavelength conversion mode (third mode) from the B light to the G light, and the mode (second mode) on which the B light is output without the wavelength conversion every frame period.

Moreover, regarding the operation of the phase modulator 4, as it can be understood from the control contents of the control unit 11C described above, spatial light phase modulation to add a light intensity distribution shown by the R image (second-wavelength band image) to the reproduction image is performed on the first mode, spatial light phase modulation to add a light intensity distribution shown by the G image (third wavelength band image) to the reproduction image is performed on the third mode, and spatial light phase modulation to add a light intensity distribution shown by the B image (second-wavelength band image) to the reproduction image is performed on the second mode.

As for the light-emitting unit 2, a non-light-emitting period that is a predetermined period is inserted at the start timing of each subframe so that the above-mentioned response waiting time of the liquid crystal is provided.

That is, the control unit 11C controls the light emission of the light-emitting unit 2 so that such a non-light-emitting period is inserted at the start timing of each subframe.

Accordingly, color mixing between the subframes can be suppressed.

It should be noted that although the example in which the non-conversion region An is provided in the wavelength conversion element 8aC for time-divisionally switching and projecting the reproduction images of the different wavelength bands, i.e., the example in which the incident light in the first wavelength band is not wavelength-converted on the second mode has been described above, it is not essential to provide the non-conversion region An also in this case.

For example, also in this case, with a configuration in which the wavelength conversion region in which the light in the first wavelength band is wavelength-converted to the B light (i.e., the light in the first wavelength band is wavelength-converted to the light in the particular wavelength band different from the first wavelength band and the second wavelength band) is provided instead of the non-conversion region An as one that emits light in the first wavelength band other than R, G, and B light, such as near-ultraviolet light, from the light-emitting unit 2, it is possible to time-divisionally switch and project reproduction images of three different wavelength bands as in the above-mentioned example.

In view of this point, also in the wavelength conversion unit 8C, the second mode can be defined as a mode on which the incident light in the first wavelength band is not wavelength-converted or the incident light in the first wavelength band is wavelength-converted to the light in the particular wavelength band different from the first wavelength band and the second wavelength band. Moreover, the third mode can be defined as a mode on which the incident light in the first wavelength band is wavelength-converted to light in a wavelength band different from the first wavelength band, the second wavelength band, and the particular wavelength band.

In view of these points, it can be said that it is sufficient that as the wavelength conversion element 8aC in the wavelength conversion unit 8C, the first region (first conversion region Ac1) in which the incident light in the first wavelength band is wavelength-converted to the light in the second wavelength band, the second region in which the incident light in the first wavelength band is not wavelength-converted or the incident light in the first wavelength band is wavelength-converted to the light in the particular wavelength band, and the third region in which the incident light in the first wavelength band is wavelength-converted to the light in the wavelength band different from the first wavelength band, the second wavelength band, and the particular wavelength band are arranged in the circumferential direction.

### 4. Fourth Embodiment

In a fourth embodiment, reproduction images of three wavelength bands are projected simultaneously.

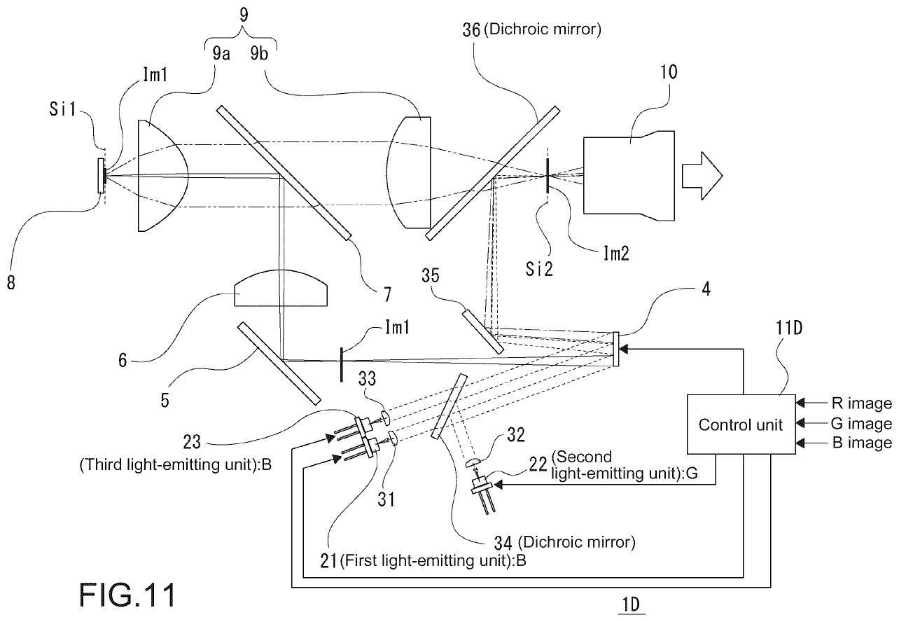

FIG. 11 is a diagram showing a configuration example of a lighting apparatus 1D as the fourth embodiment.

Differences from the lighting apparatus 1 shown in FIG. 1 are that a first light-emitting unit 21, a second light-emitting unit 22, and a third light-emitting unit 23 replace the light-emitting unit 2, collimating lenses 31, 32, and 33, a dichroic mirror 34, a mirror 35, and a dichroic mirror 36 are added, and a control unit 11D replaces the control unit 11.

Here, in the fourth embodiment, it is necessary to generate reproduction images of the three wavelength bands not time-divisionally, but simultaneously. Therefore, the phase modulation region (region for spatial light phase modulation) of the phase modulator 4 is divided into three parts so that reproduction images with light intensity distributions corresponding to the respective wavelength bands can be generated.

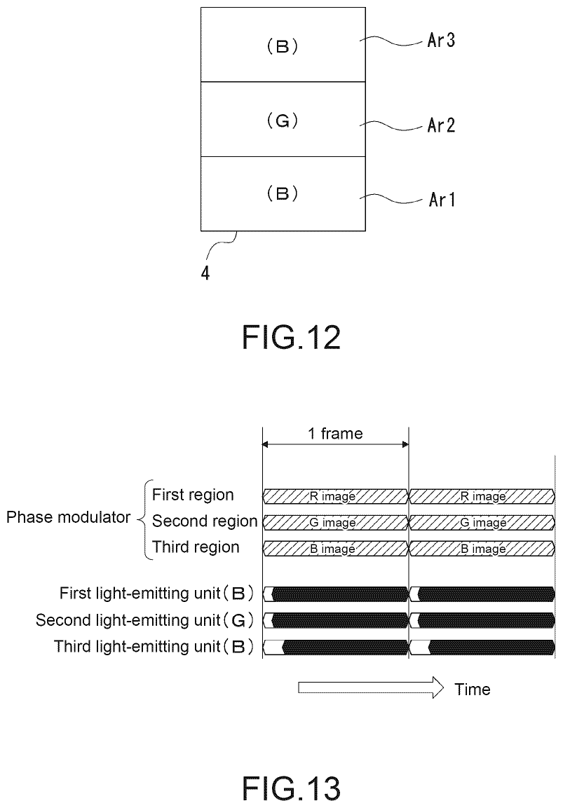

For example, a first phase modulation region Ar1, a second phase modulation region Ar2, and a third phase modulation region Ar3 as illustrated in FIG. 12 are defined. Here, an example in which the entire region of a phase modulation possible region, which is a region where phase modulation can be performed in the phase modulator 4, is divided into three equal parts in a strip shape so that the first phase modulation region Ar1, the second phase modulation region Ar2, and the third phase modulation region Ar3 are provided in order from the bottom is shown.

In FIG. 11, the first light-emitting unit 21 is provided as a light source of excitation light for the wavelength conversion unit 8 as in the light-emitting unit 2 in the first embodiment, and emits the light in the first wavelength band (B light also in this example).

The second light-emitting unit 22 emits light in a fourth wavelength band (as G light in this example) different from the first wavelength band and the second wavelength band (wavelength band wavelength-converted by the wavelength conversion unit 8).

The third light-emitting unit 23 emits light in a fifth wavelength band (as B light in this example) different from the second wavelength band and the fourth wavelength band.

As shown in the figure, the light in the first wavelength band (B light) emitted from the first light-emitting unit 21 enters one surface of the dichroic mirror 34 through a collimating lens 31 and the light in the fifth wavelength band (B light) emitted from the third light-emitting unit 23 enters one surface of the dichroic mirror 34 through a collimating lens 33.

Moreover, the light in the fourth wavelength band (G light) emitted from the second light-emitting unit 22 enters the other surface of the dichroic mirror 34 through a collimating lens 32.

The dichroic mirror 34 is configured to reflect the light in the fourth wavelength band and transmit the light in the other wavelength band. Thus, the light in the first wavelength band from the first light-emitting unit 21 and the light in the fifth wavelength band from the third light-emitting unit 23 pass through the dichroic mirror 34, the light in the second wavelength band from the second light-emitting unit 22 is reflected by the dichroic mirror 34, and the light in the first, fourth, and fifth wavelength bands is emitted toward the phase modulator 4 from the other surface of the dichroic mirror 34.

As shown in the figure, the light in the first, fourth, and fifth wavelength bands emitted from the dichroic mirror 34 are made incident on different phase modulation regions of the phase modulator 4, respectively. Specifically, in this example, the light in the first wavelength band (B light) from the first light-emitting unit 21 is made incident on the first phase modulation region Ar1, the light in the second wavelength band (G light) from the second light-emitting unit 22 is made incident on the second phase modulation region Ar2, and the light in the fifth wavelength band (B light) from the third light-emitting unit 23 is made incident on the third phase modulation region Ar3.

In the phase modulator 4 in this case, the spatial light phase modulation is performed in the first phase modulation region Ar1 by the control of the control unit 11D so that incident light in the first wavelength band (B light) is emitted toward the mirror 5 and the first reproduction image Im1 is formed once in front of the mirror 5 as in the first embodiment.

That is, the control unit 11D controls the phase modulation pattern of the first phase modulation region Ar1, thereby generating a reproduction image to be formed in the wavelength conversion unit 8 as the reproduction image of the first wavelength band.

Accordingly, also in the lighting apparatus 1D, as in the first embodiment, it is possible to form the reproduction image of the second wavelength band (reproduction image in the R light) on the second image plane Si2, and it is possible to project the reproduction image of the second wavelength band.

In the lighting apparatus 1D, the dichroic mirror 36 is inserted in the optical path between the relay lens 9b and the projection lens 10, and the dichroic mirror 36 transmits the light in the second wavelength band and reflects the light in the other wavelength band.

Here, in the lighting apparatus 1D, the mirror 35 and the above-mentioned dichroic mirror 36 are provided so that an optical path that guides light to the second image plane Si2 from the phase modulator 4 without the wavelength conversion unit 8 can be formed.

In the second phase modulation region Ar2 in the phase modulator 4, the spatial light phase modulation is performed by the control of the control unit 11D so that incident light in the fourth wavelength band (G light) is emitted toward the mirror 35 and the light in the fourth wavelength band reflected by the mirror 35 and reflected by the dichroic mirror 36 is focused on the second image plane Si.

That is, the control unit 11D controls the phase modulation pattern of the second phase modulation region Ar2, thereby generating a reproduction image to be superimposed on the image plane of the reproduction image of the second wavelength band as a reproduction image of the fourth wavelength band.

Moreover, in the third phase modulation region Ar3 in the phase modulator 4, the spatial light phase modulation is performed by the control of the control unit 11D so that incident light in the fifth wavelength band (B light) is emitted toward the mirror 35 and the light in the fifth wavelength band reflected by the mirror 35 and reflected by the dichroic mirror 36 is focused on the second image plane Si.

That is, the control unit 11D controls the phase modulation pattern of the third phase modulation region Ar3, thereby generating a reproduction image to be superimposed on the image plane of the reproduction image of the second wavelength band as a reproduction image of the fifth wavelength band.

In this manner, in the lighting apparatus 1D, the reproduction images of the R light (second wavelength band), the G light (fourth wavelength band), and the B light (fifth wavelength band) are simultaneously formed on the second image plane Si2 by the spatial light phase modulation for each phase modulation region of the phase modulator 4, and superimposed images of these reproduction images are projected by the projection lens 10.

Thus, a full-color image can be presented by simultaneously projecting the reproduction images of the three wavelength bands such as R, G, and B.

Since the images of the respective wavelength bands are not time-divisionally projected, but these are simultaneously projected as superimposed images, color breakdown can be suppressed.

Here, also in the lighting apparatus 1D according to the fourth embodiment, a reproduction image provided with a light intensity distribution based on an input image is projected as the reproduction image of each wavelength band.

For this, the control unit 11D controls the spatial light phase modulation for each region of the first phase modulation region Ar1, the second phase modulation region Ar2, and the third phase modulation region Ar3 on the basis of the R image, the G image, and the B image input in frame units.

Specifically, as for the first phase modulation region Ar1, the phase modulation pattern is controlled so that the spatial light phase modulation is performed to add a light intensity distribution shown by an input R image to the reproduction image of the first wavelength band.

Moreover, as for the second phase modulation region Ar2, the phase modulation pattern is controlled so that spatial light phase modulation to add a light intensity distribution shown by an input G image to the reproduction image of the fourth wavelength band is performed.

In addition, as for the third phase modulation region Ar3, the phase modulation pattern is controlled so that spatial light phase modulation to add a light intensity distribution shown by an input B image to the reproduction image of the fifth wavelength band is performed.

Accordingly, for each of the reproduction images of the second, fourth, and fifth wavelength bands, it is possible to provide a light intensity distribution depending on the input image of that wavelength band, and it is possible to present a full-color image by simultaneously projecting the reproduction images of those wavelength bands.

For confirmation, FIG. 13 shows a timing chart representing the operations of the phase modulator 4 and the respective light-emitting units in the lighting apparatus 1D.

As shown in the figure, as for the phase modulator 4, for each frame, the spatial light phase modulation based on the R image is performed in the first phase modulation region Ar1 (first region in the figure), the spatial light phase modulation based on the G image is performed in the second phase modulation region Ar2 (second region in the figure), and the spatial light phase modulation based on the B image is performed in the third phase modulation region Ar3 (third region in the figure).

Moreover, in this example, as for each of the first light-emitting unit 21, the second light-emitting unit 22, and the third light-emitting unit 23, a non-light-emitting period for ensuring the response waiting time of the liquid crystal described above is inserted at the start timing of each frame.

That is, the control unit 11D controls the light emission of the first light-emitting unit 21, the second light-emitting unit 22, and the third light-emitting unit 23 so that the non-light-emitting period is inserted at the start timing of each frame in this manner.

Accordingly, it is possible to prevent the image in the immediately preceding frame from being superimposed as afterimages in the subsequent frame, and it is possible to improve the quality of the projected image.

Here, although the example in which the wavelength conversion to the R light is performed in the wavelength conversion unit 8 (or 8B, 8C) has been described so far, this makes it unnecessary to use the light-emitting element that emits the R light as the light-emitting unit 2.

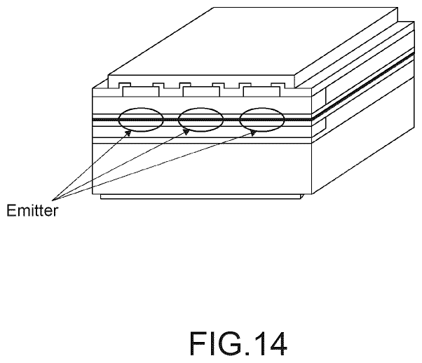

As the light-emitting element that emits the R light, the red laser (laser diode) sometimes has a larger emitter (light emission point) and uses a plurality of emitters, for example, as illustrated in FIG. 14, which makes it relatively difficult to collimate the emitted light. Such lower collimation leads to a reduction in resolution of the projected image when trying to directly obtain a direct reproduction image by the red laser.

In view of this, the above-mentioned examples employ the configuration in which the first reproduction image Im1 is generated with a higher resolution by using a blue laser (or even a green laser) whose emitter size has a relatively small impact as the light-emitting unit, and then the reproduction image in the R light is obtained by wavelength-converting it.

Accordingly, it is possible to improve the resolution of the projected image because it is unnecessary to use the red laser.

It should be noted that with respect to the fourth embodiment, it has been assumed above that the phase modulation region in the phase modulator 4 is equally divided, but it may be unequally divided.

Moreover, although the example in which the phase modulation region of the phase modulator 4 is divided into three parts to generate the reproduction image of each wavelength band has been described above, a configuration in which three phase modulators 4 are provided and each phase modulator 4 performs spatial light phase modulation for generating a reproduction image of the corresponding wavelength band can also be employed.

In this case, the phase modulation regions of the phase modulators 4 can be considered to correspond to the first phase modulation region Ar1, the second phase modulation region Ar2, and the third phase modulation region Ar3, respectively.

Moreover, the example in which assuming that the light in the second wavelength band is the R light, the light in the first wavelength band (B light) enters the first phase modulation region Ar1, the light in the fourth wavelength band (G light) enters the second phase modulation region Ar2, and the light in the fifth wavelength band (B light) enters the third phase modulation region Ar3 has been described above.

However, the light in the first wavelength band is not limited to the B light as exemplified, and it is also conceivable to use a wavelength band other than the R light, such as the G light. That is, the first wavelength band only needs to be a wavelength band other than at least the second wavelength band that is a wavelength band converted by the wavelength conversion unit 8.

Moreover, although the G light has been exemplified as the light in the fourth wavelength band, the fourth wavelength band only needs to be light in a wavelength band other than at least the second wavelength band and the fifth wavelength band.

In addition, although the B light is used as the light in the fifth wavelength band, the fifth wavelength band only needs to be a wavelength band other than at least the second wavelength band and the fourth wavelength band.

Moreover, in a case where the first wavelength band equals the fifth wavelength band as in the example of FIG. 11, the light sources of these first and fifth wavelength bands can be shared.

### 5. Fifth Embodiment

In a fifth embodiment, spatial light intensity modulation is performed on the reproduction image generated by the spatial light phase modulation.

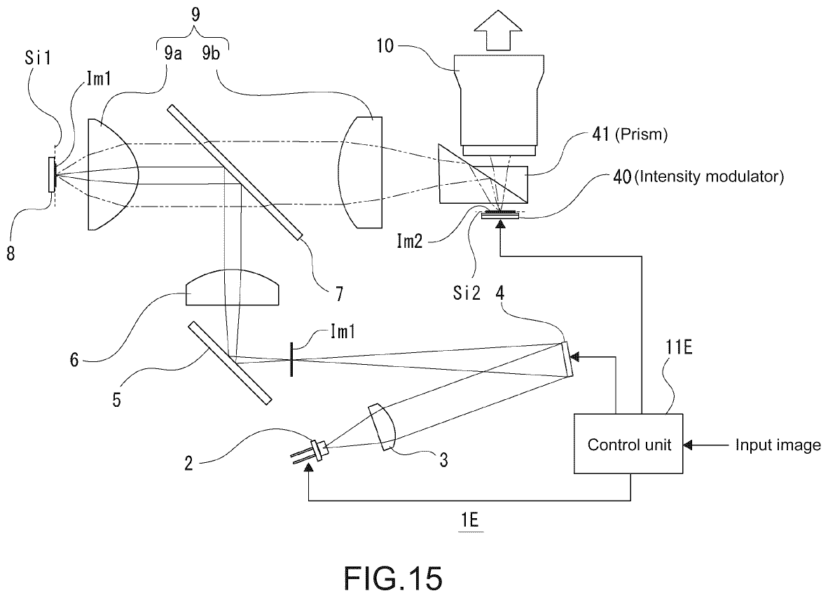

FIG. 15 is a diagram showing a configuration example of a lighting apparatus 1E as the fifth embodiment.

Differences from the lighting apparatus 1 as the first embodiment shown in FIG. 1 are that an intensity modulator 40 and a prism 41 are provided in the optical path between the relay lens 9b and the projection lens 10 in the lens optical system 9 and a control unit 11E replaces the control unit 11.

The intensity modulator 40 is a spatial light modulator that performs the spatial light intensity modulation on the incident light and is a reflective element in this example. Specifically, a digital micro mirror device (DMD) is used.

As shown in the figure, the optical axis of the light in the second wavelength band (e.g., the R light) emitted from the relay lens 9b is bent by the refractive action of the prism 41 and enters the modulation plane of the intensity modulator 40.

Then, the light in the second wavelength band subjected to the spatial light intensity modulation by the intensity modulator 40 enters the projection lens 10 through the prism 41.

At this time, in the lighting apparatus 1E, by setting the focal length of the lens optical system 9, the light in the second wavelength band is focused on the modulation plane of the intensity modulator 40, i.e., the second image plane Si2 coincides with the modulation plane, and the area of the second reproduction image Im2 formed on the second image plane Si2 is larger than the area of the first reproduction image Im1 formed in the phase modulator 4.

The control unit 11E is different from the control unit 11 in that it controls the light-emitting unit 2 and the phase modulator 4 and also controls the intensity modulator 40.

Specifically, the control unit 11E controls the spatial light phase modulation by the phase modulator 4 and the spatial light intensity modulation by the intensity modulator 40 on the basis of an input image. The phase modulator 4 controls the phase modulation pattern so that the light intensity distribution shown by the input image is added to the first reproduction image Im1.

Here, in general, the resolution of the reproduction image that can be generated by the spatial light phase modulation of the phase modulator 4 is set to be lower than the resolution of the reproduction image that can be generated by the spatial light intensity modulation of the intensity modulator 40.

Therefore, in the lighting apparatus 1E, the resolution of the projected image is improved by correcting the second reproduction image Im2, which is generated on the basis of the spatial light phase modulation of the phase modulator 4, so that the high-frequency components of the input image are supplemented by intensity modulator 40.

Specifically, the control unit 11E extracts high frequency components of the input image and controls the spatial light intensity modulation by the intensity modulator 40 so that a light intensity distribution depending on the high frequency components is added to the second reproduction image Im2 that enters the intensity modulator 40.

It should be noted that although the example in which the DMD is used as the intensity modulator 40 has been described above, another reflective spatial light intensity modulator, such as a reflective liquid-crystal panel, or a transmissive spatial light intensity modulator, such as a transmissive liquid-crystal panel, may be used as the intensity modulator 40.

Moreover, although it has been assumed above that light in a single wavelength band is projected as in the first embodiment, a configuration to time-divisionally project light in a plurality of wavelength bands as in the second and third embodiments may be added to the fifth embodiment. In this case, it is sufficient that the spatial light intensity modulation based on the input images of the respective wavelength bands is performed time-divisionally in the intensity modulator 40.

Moreover, a configuration to simultaneously project light in a plurality of wavelength bands as in the fourth embodiment may be applied to the fifth embodiment. In this case, it is conceivable that the intensity modulator 40 is provided to each wavelength band to be projected and each intensity modulator 40 performs spatial light intensity modulation based on an input image of incident light in the wavelength band.

### 6. Modified Examples

Hereinabove, various embodiments according to the present technology have been described. However, the present technology is not limited to the above-mentioned specific examples, and can take configurations as various modified examples.

For example, it is also conceivable to use a retroreflective material for the wavelength conversion unit 8.

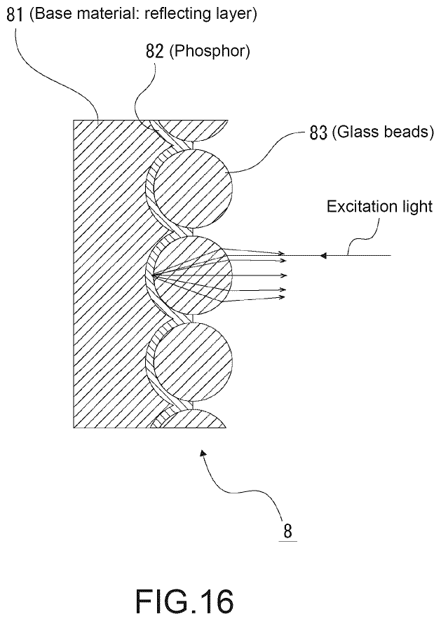

For example, it is also conceivable to employ a wavelength conversion unit 8 of a type in which glass beads 83 are exposed as illustrated in FIG. 16.

As shown in the figure, the wavelength conversion unit 8 in this case has a structure in which a layer of a phosphor 82 is formed on a base material 81 that functions as a reflecting layer and a plurality of glass beads 83 is arranged on the layer of the phosphor 82.

By the action of the glass beads 83, the retroreflectivity is achieved, and the divergence of wavelength-converted light, which is emitted from the wavelength conversion unit 8, can be suppressed.

Thus, it is possible to improve the efficiency of light capturing in the lens optical system 9. Thus, it is possible to improve the resolution of the projected image.

It should be noted that although the structure of the type in which the glass beads 83 are exposed has been exemplified above, it is also conceivable to employ another structure, for example, a closed type structure in which the glass beads 83 are not embedded as the structure for achieving the retroreflectivity.

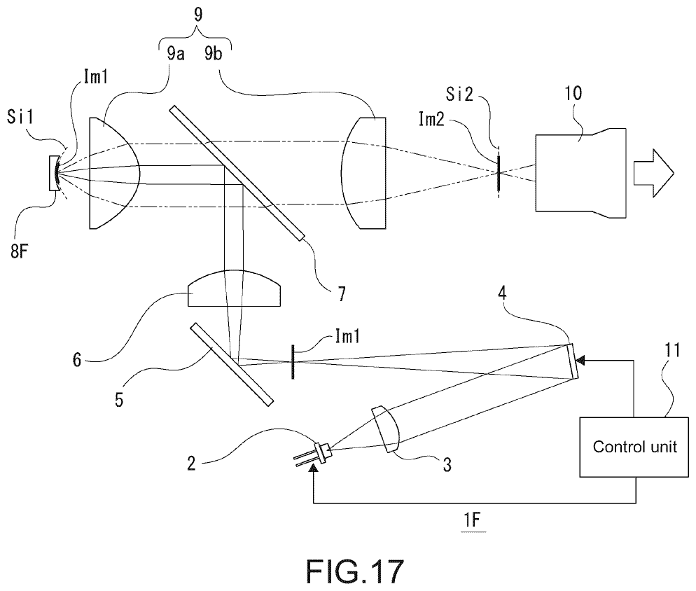

Moreover, for the wavelength conversion unit, a light-emitting surface with a curved surface may be used like a wavelength conversion unit 8F of a lighting apparatus 1F shown in FIG. 17. Specifically, the curved surface in this case is configured to be a concave curved surface (curved surface that is convex on a side opposite to the side where wavelength-converted light is emitted) as shown in the figure.

Accordingly, aberrations caused by the lens optical system, in particular, aberrations, such as image surface distortions of the reproduction image, can be corrected.

Thus, it is possible to improve the resolution of the projected image.

Moreover, although the example in which the reflective liquid-crystal panel is used as the phase modulator 4 has been described above, a spatial light phase modulator other than the reflective liquid-crystal panel may be employed as the phase modulator 4.

For example, a transmissive liquid-crystal panel can be employed. Moreover, it is not limited to the liquid-crystal panel, and a device other than the liquid-crystal panel, such as a device based on micro electro mechanical systems (MEMS) (e.g., a device configured so that the height of the mirror surface is adjustable for each pixel), may be used.

### 7. Summary of Embodiments

As described above, a lighting apparatus (lighting apparatus 1, 1A, 1B, 1C, 1D, 1E, 1F) as an embodiment includes a light-emitting unit (light-emitting unit 2, 21) that emits light in a first wavelength band, a phase modulation unit (phase modulation unit 4) that performs spatial light phase modulation on incident light from the light-emitting unit, a wavelength conversion unit (wavelength conversion unit 8, 8B, 8C, 8F) that wavelength-converts incident light from the phase modulation unit, thereby emitting light in the second wavelength band different from the first wavelength band, and a lens optical system (lens optical system 9) that guides emitted light from the wavelength conversion unit to a projection lens, in which the phase modulation unit generates a reproduction image that is formed in the wavelength conversion unit as a reproduction image of the first wavelength band, and the lens optical system forms a reproduction image of the second wavelength band in an optical path between the projection lens and the lens optical system on the basis of the emitted light from the wavelength conversion unit.

That is, the reproduction image of the second wavelength band obtained by the wavelength conversion of the wavelength conversion unit is not directly magnified and projected by the projection lens, but the reproduction image of the second wavelength band is formed once in front of the projection lens, and then the reproduction image of the second wavelength band is magnified and projected by the projection lens. Accordingly, the NA of the projection lens can be reduced as compared to a case where the reproduction image of the second wavelength band obtained by the wavelength conversion of the wavelength conversion unit is directly magnified and projected by the projection lens.

The capability of reducing the NA of the projection lens can reduce the size and weight of the lighting apparatus. Moreover, the ability to reduce the NA of the projection lens makes it possible to the aberrations of the projection lens. Thus, it is possible to improve the resolution of the projected image.

Moreover, the lighting apparatus as the embodiment includes a control unit that controls the phase modulation unit (phase modulation unit 11C, 11D, 11E), in which the control unit controls the phase modulation unit so that spatial light phase modulation to provide a light intensity distribution based on an input image to the reproduction image is performed (see the third and fifth embodiments).

Accordingly, it is possible to project a reproduction image based on the input image. That is, image projection can be realized.

In addition, in the lighting apparatus as the embodiment, the reproduction image of the second wavelength band has an area larger than an area of the reproduction image of the first wavelength band that is formed in the wavelength conversion unit.

Accordingly, it is possible to reduce the amount of blur caused by image surface distortion for the reproduction image of the second wavelength band.

Thus, it is possible to suppress the reduction in resolution of the projected image, which is caused by the image surface distortion of the reproduction image of the second wavelength band.

Furthermore, in the lighting apparatus as the embodiment, the lens optical system is configured as a relay lens optical system.

Accordingly, the reproduction image of the second wavelength band can be suitably formed in front of the projection lens. Moreover, the size of the reproduction image of the second wavelength band can be easily adjusted by the magnification adjustment function of the relay lens optical system.

Moreover, in the lighting apparatus (lighting apparatus 1B, 1C) as the embodiment, the wavelength conversion unit (wavelength conversion unit 8B, 8C) is configured to be capable of time-divisionally switching between the first mode on which the incident light in the first wavelength band is wavelength-converted to the light in the second wavelength band different from the first wavelength band and the second mode on which the incident light in the first wavelength band is not wavelength-converted or the incident light in the first wavelength band is wavelength-converted to the light in the particular wavelength band different from the first wavelength band and the second wavelength band.

Accordingly, it is possible to time-divisionally switch and project between at least the reproduction image of the second wavelength band (on the first mode) and the reproduction image of the first wavelength band (in a case where the wavelength conversion is not performed on the second mode) or the reproduction image of the particular wavelength band (in a case where the wavelength conversion is performed on the second mode).

In addition, in the lighting apparatus as the embodiment, the wavelength conversion unit includes the wavelength conversion element (wavelength conversion element 8a, 8aC) the first region (conversion region Ac, first conversion region Ac1) in which the incident light in the first wavelength band is wavelength-converted to the light in the second wavelength band and the second region in which the incident light in the first wavelength band is not wavelength-converted or the incident light in the first wavelength band is wavelength-converted to the light in the particular wavelength band (non-conversion region An) are arranged in the circumferential direction, and the rotary drive unit (rotary drive unit 8b) that rotationally drives the wavelength conversion element.

That is, it is capable of time-divisionally switching between the first mode and the second mode by the rotary drive unit rotationally driving the wavelength conversion element.

By using the method of rotationally driving the wavelength conversion element the first region and the second region are formed in the circumferential direction as described above, it is possible to stably perform time-division switching between the first mode and the second mode. In addition, the temperature rise of the first region can be suppressed because the light irradiation region in the first region is dispersed over time. Thus, it is possible to improve the light-emitting efficiency in the first region.

Furthermore, in the lighting apparatus (lighting apparatus 1C) as the embodiment, the wavelength conversion unit (wavelength conversion unit 8C) is configured to be capable of time-divisionally switching between the first mode, the second mode, and a third mode on which incident light in the first wavelength band is wavelength-converted to light in a wavelength band different from the first wavelength band, the second wavelength band, and the particular wavelength band.

Accordingly, it is possible to time-divisionally switch and project reproduction images of three types of wavelength bands, the reproduction image of the second wavelength band (on the first mode), the reproduction image of the first wavelength band (in a case where the wavelength conversion is not performed on the second mode) or the reproduction image of the particular wavelength band (in a case where the wavelength conversion is performed on the second mode), and the reproduction image of the still another wavelength band (on the third mode).

For example, it is possible to switch and project the reproduction images of R, G, and B as the reproduction images of the three types of wavelength bands. If switching between the first, second, and third modes is performed at a sufficiently high speed, a full-color image can be projected by utilizing the integral effect of the human eye.

Moreover, the lighting apparatus as the embodiment includes a control unit that controls the phase modulation unit (phase modulation unit 1C), in which assuming that a wavelength band of emitted light on the second mode of the wavelength conversion unit is a second-mode wavelength band and a wavelength band of emitted light on the third mode of the wavelength conversion unit is a third-mode wavelength band, the control unit receives input of a second-wavelength band image showing a light intensity distribution that should be added to the reproduction image of the second wavelength band, a second-mode wavelength band image showing a light intensity distribution that should be added to a reproduction image of the second-mode wavelength band, and a third-mode wavelength band image showing a light intensity distribution that should be added to a reproduction image of the third-mode wavelength band, and controls, on the first mode, the phase modulation unit so that spatial light phase modulation to add the light intensity distribution shown by the second-wavelength band image to the reproduction image is performed, controls, on the second mode, the phase modulation unit so that spatial light phase modulation to add the light intensity distribution shown by the second-mode wavelength band image to the reproduction image is performed, and controls, on the third mode, the phase modulation unit so that spatial light phase modulation to add the light intensity distribution shown by the third-mode wavelength band image to the reproduction image is performed.

Accordingly, for each reproduction image of the second wavelength band, the second-mode wavelength band, and the third-mode wavelength band, it is possible to provide a light intensity distribution depending on the input image of that wavelength band, and a full-color image can be presented by time-divisionally projecting the reproduction images of those wavelength bands.

In addition, in the lighting apparatus (lighting apparatus 1D) as the embodiment, the phase modulation unit includes a first phase modulation region (first phase modulation region Ar1) on which light in the first wavelength band is made incident, a second phase modulation region (second phase modulation region Ar2) on which light in a fourth wavelength band is made incident, the fourth wavelength band being a wavelength band different from the second wavelength band, and a third phase modulation region (third phase modulation region Ar3) on which light in a fifth wavelength band is made incident, the fifth wavelength band being a wavelength band different from the second wavelength band and the fourth wavelength band, generates a reproduction image to be formed in the wavelength conversion unit as the reproduction image of the first wavelength band by the spatial light phase modulation in the first phase modulation region, generates a reproduction image to be superimposed on an image plane of the reproduction image of the second wavelength band as a reproduction image of the fourth wavelength band by the spatial light phase modulation in the second phase modulation region, and generates a reproduction image to be superimposed on the image plane of the reproduction image of the second wavelength band as a reproduction image of the fifth wavelength band by the spatial light phase modulation in the third phase modulation region.

Accordingly, for example, it is possible to project superimposed images of at least the three types of wavelength bands, such as the second wavelength band=R, the fourth wavelength band=G, and the fifth wavelength band=B, and it is possible to present a full-color image. Since the images of the respective wavelength bands are not time-divisionally projected, but these are simultaneously projected as superimposed images, color breakdown can be suppressed.

Furthermore, the lighting apparatus as the embodiment includes a control unit that controls the phase modulation unit (phase modulation unit 11D), in which the control unit receives input of a second-wavelength band image showing a light intensity distribution that should be added to the reproduction image of the second wavelength band, a fourth-wavelength band image showing a light intensity distribution that should be added to the reproduction image of the fourth wavelength band, and a fifth-wavelength band image showing a light intensity distribution that should be added to the reproduction image of the fifth wavelength band, and controls the phase modulation unit so that the spatial light phase modulation to add the light intensity distribution shown by the second-wavelength band image to the reproduction image of the first wavelength band is performed in the first phase modulation region, the spatial light phase modulation to add a light intensity distribution shown by the fourth-wavelength band image to the reproduction image of the fourth wavelength band is performed in the second phase modulation region, and the spatial light phase modulation to add a light intensity distribution shown by the fifth-wavelength band image to the reproduction image of the fifth wavelength band is performed in the third phase modulation region.

Accordingly, for each of the reproduction images of the second, fourth, and fifth wavelength bands, it is possible to provide a light intensity distribution depending on the input image of that wavelength band, and it is possible to present a full-color image by simultaneously projecting the reproduction images of those wavelength bands.

Moreover, the lighting apparatus (lighting apparatus 1E) as the embodiment includes an intensity modulator (intensity modulator 40) that performs spatial light intensity modulation on an image plane of the reproduction image of the second wavelength band.

With the intensity modulator as described above, it is possible to adjust the light intensity distribution of the reproduction image.

Thus, it is possible to improve the resolution of the projected image.

In addition, in the lighting apparatus as the embodiment, the wavelength conversion unit has retroreflectivity (see FIG. 16).

Accordingly, the divergence of light in the second wavelength band emitted from the wavelength conversion unit to the lens optical system is suppressed.

Thus, it is possible to improve the efficiency of light capturing in the lens optical system. Thus, it is possible to improve the resolution of the projected image.

Furthermore, in the lighting apparatus (lighting apparatus 1F) as the embodiment, the light-emitting surface in the wavelength conversion unit (wavelength conversion unit 8F) includes a curved surface.

Accordingly, aberrations caused by the lens optical system, in particular, aberrations, such as image surface distortions of the reproduction image, can be corrected.

Thus, it is possible to improve the resolution of the projected image.

It should be noted that the effects described herein are examples only and are not limited, and other effects may be provided.

### 8. Present Technology

The present technology may take the following configurations.
(1) A lighting apparatus, including:
   a light-emitting unit that emits light in a first wavelength band;
   a phase modulation unit that performs spatial light phase modulation on incident light from the light-emitting unit;
   a wavelength conversion unit that wavelength-converts incident light from the phase modulation unit, thereby emitting light in a second wavelength band different from the first wavelength band; and
   a lens optical system that guides emitted light from the wavelength conversion unit to a projection lens, in which
   the phase modulation unit generates a reproduction image that is formed in the wavelength conversion unit as a reproduction image of the first wavelength band, and
   the lens optical system forms a reproduction image of the second wavelength band in an optical path between the projection lens and the lens optical system on the basis of the emitted light from the wavelength conversion unit.
(2) The lighting apparatus according to (1), further including
   a control unit that controls the phase modulation unit, in which
   the control unit controls the phase modulation unit so that the spatial light phase modulation to provide a light intensity distribution based on an input image to the reproduction image is performed.
(3) The lighting apparatus according to (1) or (2), in which
   the reproduction image of the second wavelength band has an area larger than an area of the reproduction image of the first wavelength band that is formed in the wavelength conversion unit.
(4) The lighting apparatus according to any of (1) to (3), in which
   the lens optical system is a relay lens optical system.
(5) The lighting apparatus according to any of (1) to (3), in which
   the wavelength conversion unit is configured to be capable of time-divisionally switching a first mode on which incident light in the first wavelength band is wavelength-converted to the light in the second wavelength band different from the first wavelength band and a second mode on which incident light in the first wavelength band is not wavelength-converted or light in a particular wavelength band different from the first wavelength band and the second wavelength band is wavelength-converted.
(6) The lighting apparatus according to (5), in which
   the wavelength conversion unit includes
      a wavelength conversion element in which a first region and a second region are arranged in a circumferential direction, the first region wavelength-converting incident light in the first wavelength band to light in the second wavelength band, the second region not wavelength-converting incident light in the first wavelength band or wavelength-converting light in the particular wavelength band, and
      a rotary drive unit that rotationally drives the wavelength conversion element.
(7) The lighting apparatus according to (4) or (5), in which
   the wavelength conversion unit is configured to be capable of time-divisionally switching between the first mode, the second mode, and a third mode on which incident light in the first wavelength band is wavelength-converted to light in a wavelength band different from the first wavelength band, the second wavelength band, and the particular wavelength band.
(8) The lighting apparatus according to (7), further including
   a control unit that controls the phase modulation unit, in which
   assuming that a wavelength band of emitted light on the second mode of the wavelength conversion unit is a second-mode wavelength band and a wavelength band of emitted light on the third mode of the wavelength conversion unit is a third-mode wavelength band,
   the control unit
   receives input of a second-wavelength band image showing a light intensity distribution that should be added to the reproduction image of the second wavelength band, a second-mode wavelength band image showing a light intensity distribution that should be added to a reproduction image of the second-mode wavelength band, and a third-mode wavelength band image showing a light intensity distribution that should be added to a reproduction image of the third-mode wavelength band, and
   controls, on the first mode, the phase modulation unit so that spatial light phase modulation to add the light intensity distribution shown by the second-wavelength band image to the reproduction image is performed,
   controls, on the second mode, the phase modulation unit so that spatial light phase modulation to add the light intensity distribution shown by the second-mode wavelength band image to the reproduction image is performed, and
   controls, on the third mode, the phase modulation unit so that spatial light phase modulation to add the light intensity distribution shown by the third-mode wavelength band image to the reproduction image is performed.
(9) The lighting apparatus according to any of (1) to (4), in which
   the phase modulation unit
   includes
      a first phase modulation region on which light in the first wavelength band is made incident,
      a second phase modulation region on which light in a fourth wavelength band is made incident, the fourth wavelength band being a wavelength band different from the second wavelength band, and
      a third phase modulation region on which light in a fifth wavelength band is made incident, the fifth wavelength band being a wavelength band different from the second wavelength band and the fourth wavelength band,
   generates a reproduction image to be formed in the wavelength conversion unit as the reproduction image of the first wavelength band by the spatial light phase modulation in the first phase modulation region,
   generates a reproduction image to be superimposed on an image plane of the reproduction image of the second wavelength band as a reproduction image of the fourth wavelength band by the spatial light phase modulation in the second phase modulation region, and
   generates a reproduction image to be superimposed on the image plane of the reproduction image of the second wavelength band as a reproduction image of the fifth wavelength band by the spatial light phase modulation in the third phase modulation region.
(10) The lighting apparatus according to (9), further including
   a control unit that controls the phase modulation unit, in which
   the control unit
   receives input of a second-wavelength band image showing a light intensity distribution that should be added to the reproduction image of the second wavelength band, a fourth-wavelength band image showing a light intensity distribution that should be added to the reproduction image of the fourth wavelength band, and a fifth-wavelength band image showing a light intensity distribution that should be added to the reproduction image of the fifth wavelength band, and
   controls the phase modulation unit so that the spatial light phase modulation to add the light intensity distribution shown by the second-wavelength band image to the reproduction image of the first wavelength band is performed in the first phase modulation region, the spatial light phase modulation to add a light intensity distribution shown by the fourth-wavelength band image to the reproduction image of the fourth wavelength band is performed in the second phase modulation region, and the spatial light phase modulation to add a light intensity distribution shown by the fifth-wavelength band image to the reproduction image of the fifth wavelength band is performed in the third phase modulation region.
(11) The lighting apparatus according to any of (1) to (10), further including
   an intensity modulator that performs spatial light intensity modulation on an image plane of the reproduction image of the second wavelength band.
(12) The lighting apparatus according to any of (1) to (11), in which
   the wavelength conversion unit has retroreflectivity.
(13) The lighting apparatus according to any of (1) to (12), in which
   a light-emitting surface in the wavelength conversion unit includes a curved surface.

### REFERENCE SIGNS LIST

1, 1A, 1B, 1C, 1D, 1E, 1F lighting apparatus
2 light-emitting unit
3, 6 collimating lens
4 phase modulator
5 mirror
7 dichroic mirror
8, 8B, 8C, 8F wavelength conversion unit
9, 9′ lens optical system
9a, 9b relay lens
10 projection lens
11, 11C, 11D, 11E control unit
Im1 first reproduction image
Im2 second reproduction image
Si1 first image plane
Si2 second image plane
12 mirror
13 polarization separation dichroic mirror
14 quarter-wave plate
8a, 8aC wavelength conversion element
8b rotary drive unit
Ac conversion region
An non-conversion region
Ac1 first conversion region
Ac2 second conversion region
21 first light-emitting unit
22 second light-emitting unit
23 third light-emitting unit
31, 32, 33 collimating lens
34, 36 dichroic mirror
35 mirror
Ar1 first phase modulation region
Ar2 second phase modulation region
Ar3 third phase modulation region
40 intensity modulator
41 prism
81 base material
82 phosphor
83 glass beads

What is claimed is:

1. A lighting apparatus, comprising:
a light-emitting unit that emits light in a first wavelength band;
a phase modulation unit that performs spatial light phase modulation on incident light from the light-emitting unit;
a wavelength conversion unit that wavelength-converts incident light from the phase modulation unit, thereby emitting light in a second wavelength band different from the first wavelength band; and
a lens optical system that guides emitted light from the wavelength conversion unit to a projection lens, wherein
the phase modulation unit generates a reproduction image that is formed in the wavelength conversion unit as a reproduction image of the first wavelength band, and
the lens optical system forms a reproduction image of the second wavelength band in an optical path between the projection lens and the lens optical system on a basis of the emitted light from the wavelength conversion unit.

2. The lighting apparatus according to claim 1, further comprising
a control unit that controls the phase modulation unit, wherein
the control unit controls the phase modulation unit so that the spatial light phase modulation to provide a light intensity distribution based on an input image to the reproduction image is performed.

3. The lighting apparatus according to claim 1, wherein
the reproduction image of the second wavelength band has an area larger than an area of the reproduction image of the first wavelength band that is formed in the wavelength conversion unit.

4. The lighting apparatus according to claim 1, wherein
the lens optical system is a relay lens optical system.

5. The lighting apparatus according to claim 1, wherein
the wavelength conversion unit is configured to be capable of time-divisionally switching a first mode on which incident light in the first wavelength band is wavelength-converted to the light in the second wavelength band different from the first wavelength band and a second mode on which incident light in the first wavelength band is not wavelength-converted or light in a particular wavelength band different from the first wavelength band and the second wavelength band is wavelength-converted.

6. The lighting apparatus according to claim 5, wherein
the wavelength conversion unit includes
a wavelength conversion element in which a first region and a second region are arranged in a circumferential direction, the first region wavelength-converting incident light in the first wavelength band to light in the second wavelength band, the second region not wavelength-converting incident light in the first wavelength band or wavelength-converting light in the particular wavelength band, and
a rotary drive unit that rotationally drives the wavelength conversion element.

7. The lighting apparatus according to claim 4, wherein
the wavelength conversion unit is configured to be capable of time-divisionally switching between the first mode, the second mode, and a third mode on which incident light in the first wavelength band is wavelength-converted to light in a wavelength band different from the first wavelength band, the second wavelength band, and the particular wavelength band.

8. The lighting apparatus according to claim 7, further comprising
a control unit that controls the phase modulation unit, wherein
assuming that a wavelength band of emitted light on the second mode of the wavelength conversion unit is a second-mode wavelength band and a wavelength band of emitted light on the third mode of the wavelength conversion unit is a third-mode wavelength band,
the control unit
receives input of a second-wavelength band image showing a light intensity distribution that should be added to the reproduction image of the second wavelength band, a second-mode wavelength band image showing a light intensity distribution that should be added to a reproduction image of the second-mode wavelength band, and a third-mode wavelength band image showing a light intensity distribution that should be added to a reproduction image of the third-mode wavelength band, and
controls, on the first mode, the phase modulation unit so that spatial light phase modulation to add the light intensity distribution shown by the second-wavelength band image to the reproduction image is performed,
controls, on the second mode, the phase modulation unit so that spatial light phase modulation to add the light intensity distribution shown by the second-mode wavelength band image to the reproduction image is performed, and
controls, on the third mode, the phase modulation unit so that spatial light phase modulation to add the light intensity distribution shown by the third-mode wavelength band image to the reproduction image is performed.

9. The lighting apparatus according to claim 1, wherein
the phase modulation unit
includes
a first phase modulation region on which light in the first wavelength band is made incident,
a second phase modulation region on which light in a fourth wavelength band is made incident, the fourth wavelength band being a wavelength band different from the second wavelength band, and
a third phase modulation region on which light in a fifth wavelength band is made incident, the fifth wavelength band being a wavelength band different from the second wavelength band and the fourth wavelength band,
generates a reproduction image to be formed in the wavelength conversion unit as the reproduction image of the first wavelength band by the spatial light phase modulation in the first phase modulation region,
generates a reproduction image to be superimposed on an image plane of the reproduction image of the second wavelength band as a reproduction image of the fourth wavelength band by the spatial light phase modulation in the second phase modulation region, and
generates a reproduction image to be superimposed on the image plane of the reproduction image of the second wavelength band as a reproduction image of the fifth wavelength band by the spatial light phase modulation in the third phase modulation region.

10. The lighting apparatus according to claim 9, further comprising
a control unit that controls the phase modulation unit, wherein
the control unit
receives input of a second-wavelength band image showing a light intensity distribution that should be added to the reproduction image of the second wavelength band, a fourth-wavelength band image showing a light intensity distribution that should be added to the reproduction image of the fourth wavelength band, and a fifth-wavelength band image showing a light intensity distribution that should be added to the reproduction image of the fifth wavelength band, and
controls the phase modulation unit so that the spatial light phase modulation to add the light intensity distribution shown by the second-wavelength band image to the reproduction image of the first wavelength band is performed in the first phase modulation region, the spatial light phase modulation to add a light intensity distribution shown by the fourth-wavelength band image to the reproduction image of the fourth wavelength band is performed in the second phase modulation region, and the spatial light phase modulation to add a light intensity distribution shown by the fifth-wavelength band image to the reproduction image of the fifth wavelength band is performed in the third phase modulation region.

11. The lighting apparatus according to claim 1, further comprising
an intensity modulator that performs spatial light intensity modulation on an image plane of the reproduction image of the second wavelength band.

12. The lighting apparatus according to claim 1, wherein
the wavelength conversion unit has retroreflectivity.

13. The lighting apparatus according to claim 1, wherein
a light-emitting surface in the wavelength conversion unit includes a curved surface.
